(19) United States
(12) Patent Application Publication
(10) Pub. No.: US 2026/0291413 A1
(43) Pub. Date: Sep. 24, 2026

(54) MOTOR CONTROL DEVICE

(71) Applicant: FANUC CORPORATION, Yamanashi (JP)

(72) Inventor: Yasuyoshi URATA, Minamitsuru-gun, Yamanashi (JP)

(73) Assignee: FANUC CORPORATION, Yamanashi (JP)

(21) Appl. No.: 19/470,015

(22) PCT Filed: Apr. 5, 2023
(86) PCT No.: PCT/JP2023/014091

§ 371 Date: Sep. 26, 2025

(51) Int. Cl. H02P 6/24; H02P 6/06; H02P 6/20; H02P 23/14; H02P 23/20

(52) U.S. Cl. CPC H02P 6/24; H02P 6/06; H02P 6/20; H02P 23/14; H02P 23/20

(57) ABSTRACT

Provided is a technique capable of shortening a start-up time after recovery from a power failure even when the power failure or the like occurred when a spindle motor was rotating. A motor control device 1 includes: a speed detection unit 11 that detects a speed of a spindle motor; an initial speed storage unit 12 that stores an initial speed of the spindle motor immediately after power is turned on; an initial state determination unit 13 that compares the initial speed of the spindle motor with a speed zero detection level to determine whether an initial state of the spindle motor immediately after power is turned on is a rotation state; a stop determination unit 15 that compares a present speed of the spindle motor with a speed zero detection level according to the determination result of the initial state determination unit 13 to determine stop of the spindle motor when it is determined that the spindle motor is presently also in the rotation state; and a control stop unit 16 that stops the control of the spindle motor according to the determination result of the stop determination unit 15.

### TECHNICAL FIELD

The present disclosure relates to a motor control device.

### BACKGROUND ART

Conventionally, when a power failure or the like occurs while the spindle motor of a machine tool is rotating, it is known that the spindle motor continues to rotate by inertia, being no longer under the control of the motor control device. For example, techniques have been disclosed to prevent an excessive rise in the DC voltage due to regenerative energy in a synchronous motor that is in such a rotating state (see, for example, Patent Document 1).

### CITATION LIST

### Patent Document

Patent Document 1: Japanese Unexamined Patent Application, Publication No. 2012-249397

### DISCLOSURE OF THE INVENTION

### Problems to be Solved by the Invention

Meanwhile, in a case where a power failure or the like occurs while the spindle motor is rotating at high speed, it takes time for the spindle motor rotating by inertia to come to a stop. Therefore, even if the motor control device is restarted shortly after power is restored, the spindle motor may still be in a rotating state. In such a case, it has been necessary to wait until the spindle motor naturally comes to a stop before restarting the spindle motor.

The present disclosure has been made in view of the above-described issues, and an object thereof is to provide a technique capable of shortening the startup time after power restoration, even in a case where a power failure or the like occurs while the spindle motor is rotating.

### Means for Solving the Problems

The present disclosure provides a motor control device configured to control a spindle motor of an industrial machine, the motor control device including: a speed detection unit configured to detect a speed of the spindle motor; an initial speed storage unit configured to store an initial speed of the spindle motor immediately after power-on, the initial speed being detected by the speed detection unit; an initial state determination unit configured to compare the initial speed of the spindle motor stored in the initial speed storage unit with a preset zero-speed detection level serving as a reference for regarding the speed of the spindle motor as zero, thereby determining whether an initial state of the spindle motor immediately after power-on is a rotating state; a stop determination unit configured to compare a current speed of the spindle motor detected by the speed detection unit with the zero-speed detection level, in accordance with a determination result of the initial state determination unit, thereby determining that the spindle motor should be stopped, in a case of determining that the spindle motor is still in a rotating state; and a control stop unit configured to execute control stop of the spindle motor, in accordance with a determination result of the stop determination unit.

### Effects of the Invention

According to the present disclosure, it is possible to provide a motor control device capable of shortening the startup time after power restoration, even in a case where a power failure or the like occurs while the spindle motor is rotating.

### BRIEF DESCRIPTION OF THE DRAWINGS

FIG. 1 is a functional block diagram of a motor control device according to an embodiment of the present disclosure;

FIG. 2 is a flowchart illustrating the procedure of control processing by the motor control device according to an embodiment of the present disclosure;

FIG. 3 is a flowchart illustrating the procedure of control stop processing by the motor control device according to an embodiment of the present disclosure;

FIG. 4 is a time chart illustrating an example of changes in spindle speed in a case where the spindle motor is an induction motor; and

FIG. 5 is a time chart illustrating an example of changes in spindle speed in a case where the spindle motor is a synchronous motor.

### PREFERRED MODE FOR CARRYING OUT THE INVENTION

Hereinafter, an embodiment of the present disclosure will be described in detail with reference to the drawings.

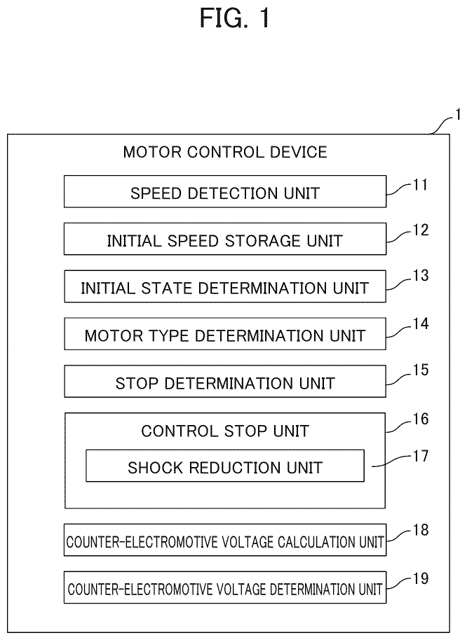

FIG. 1 is a functional block diagram of a motor control device 1 according to an embodiment of the present disclosure. The motor control device 1 of the present embodiment is a motor control device capable of shortening the startup time after power recovery by executing control stop of the spindle motor even in a case where a power failure or the like occurs while the spindle motor is rotating.

The motor control device 1 of the present embodiment controls a spindle motor of an industrial machine (not illustrated). The industrial machine may be, for example, a machine tool or a robot. As the spindle motor, i.e., the main spindle motor of such industrial machines, an induction motor or a synchronous motor may be used.

The motor control device 1 of the present embodiment is configured using a computer including, for example, a memory such as a ROM (read only memory) or a RAM (random access memory), a CPU (central processing unit), and a communication control unit, all connected to each other via a bus. The functions and operations of the respective functional units described below are achieved by cooperation among the CPU and memory mounted in the computer and a control program stored in the memory. The motor control device 1 may include a numerical control device (CNC: Computer Numerical Controller), a PLC (Programmable Logic Controller), or the like, and may be connected to a higher-level computer that outputs a machining program, machining conditions such as rotational speed, etc.

As illustrated in FIG. 1, the motor control device 1 includes, as functional units, a speed detection unit 11, an initial speed storage unit 12, an initial state determination unit 13, a motor type determination unit 14, a stop determination unit 15, a control stop unit 16 including a shock reduction unit 17, a counter-electromotive voltage calculation unit 18, and a counter-electromotive voltage determination unit 19.

The speed detection unit 11 detects the speed of the spindle motor. Specifically, the speed detection unit 11 acquires detection signals from sensors such as an encoder provided on the spindle motor, and detects the speed (rotation number) of the spindle motor, based on the detection signals.

The initial speed storage unit 12 stores the initial speed of the spindle motor immediately after power is turned on, the speed being detected by the speed detection unit 11. More specifically, the initial speed storage unit 12 stores, as the initial speed, the speed of the spindle motor detected by the speed detection unit 11 immediately after power is supplied to devices such as the numerical control device or the amplifier, following recovery from a power failure or the like.

The initial state determination unit 13 compares the initial speed of the spindle motor stored in the initial speed storage unit 12 with a zero-speed detection level, thereby determining whether the initial state of the spindle motor immediately after power-on is a rotating state. More specifically, in a case where the initial speed of the spindle motor stored in the initial speed storage unit 12 is greater than the zero-speed detection level, the initial state determination unit 13 determines that the initial state of the spindle motor immediately after power-on is a rotating state.

The fact that the initial state of the spindle motor immediately after power-on is a rotating state indicates that the spindle motor is rotating by inertia in a condition of not under the control of the motor control device 1 due to a power failure or the like. The motor control device 1 of the present embodiment controls a control stop unit 16, described below, to execute control stop of the spindle motor without waiting for such inertia-based rotation to stop naturally. It should be noted that such inertia-based rotation is referred to as a coasting (free-running) state in the case of an induction motor. In contrast, in the case of a synchronous motor, unlike an induction motor, a permanent magnet is embedded in the rotor, and when the spindle motor rotates by inertia following a power failure or the like, the synchronous motor operates as a generator, resulting in high voltage being generated at the power line terminals. Therefore, in the case of a synchronous motor, a dynamic braking circuit is provided as a safety circuit. The dynamic braking circuit applies braking to the motor's rotation by converting the rotational energy into Joule heat through resistive short-circuiting of the power lines including a plurality of windings. Since this dynamic braking circuit is activated, the aforementioned rotating state is referred to as a dynamic braking operation state.

The zero-speed detection level serves as a reference for regarding the spindle motor speed as zero and is set in advance, based on experiments or the like. This is because, even in a case where the spindle motor has actually come to a complete stop, the spindle motor may still exhibit vibrations or slight rotation due to external disturbances or other influences. Therefore, the speed of the spindle motor under such a fully stopped condition is acquired in advance, and the zero-speed detection level is set based on the acquired speed. By comparing this zero-speed detection level with the initial speed, the rotational state of the spindle motor can be determined more accurately.

The motor type determination unit 14 determines the type of the spindle motor. Specifically, the motor type determination unit 14 determines whether the spindle motor is an induction motor or a synchronous motor. For example, the motor type determination unit 14 makes the determination, based on a machining program, user input information, or an external signal, to identify whether the spindle motor is an induction motor or a synchronous motor.

The stop determination unit 15 compares the current speed of the spindle motor detected by the speed detection unit 11 with the zero-speed detection level, based on the determination result of the initial state determination unit 13, thereby determining that the spindle motor should be stopped. More specifically, in a case where the current speed of the spindle motor detected by the speed detection unit 11 is greater than the zero-speed detection level, the stop determination unit 15 determines that the spindle motor is still in a rotating state, and determines that the spindle motor should be stopped. This configuration makes it possible to avoid a situation in which, despite the spindle motor no longer being in a rotating state, the control stop unit 16 described later unnecessarily executes control stop, in the case where the initial state determination unit 13 previously determined that the spindle motor was in a rotating state immediately after power-on.

The control stop unit 16 executes control stop of the spindle motor in accordance with the determination result of the stop determination unit 15. Specifically, the control stop unit 16 executes control stop of the spindle motor by exciting the spindle motor with a speed command value of zero. As a result, the spindle motor promptly transitions from a rotating state to a stopped state. The control stop unit 16 includes a shock reduction unit 17 that reduces shock (excessive load) generated in the spindle motor when executing control stop of the spindle motor. The shock reduction unit 17 will be described in detail later.

Further, in a case where the motor type determination unit 14 determines that the spindle motor is a synchronous motor, the control stop unit 16 executes control stop of the spindle motor, based on the determination results of both the stop determination unit 15 and a counter-electromotive voltage determination unit 19. The counter-electromotive voltage determination unit 19 will be described later.

The shock reduction unit 17 reduces the shock (excessive load) applied to the spindle motor when executing control stop of the spindle motor. Specifically, the shock reduction unit 17 reduces the shock to the spindle motor by limiting the torque command value for the spindle motor. For example, the shock reduction unit 17 may reduce the shock to the spindle motor by initially setting a small torque command value for the spindle motor and then gradually increasing the torque command value. Alternatively, the shock reduction unit 17 may reduce the shock by decelerating the spindle motor using a time constant, based on the current speed of the spindle motor detected by the speed detection unit 11.

The counter-electromotive voltage calculation unit 18 calculates the counter-electromotive voltage of the spindle motor at the current speed, based on the current speed of the spindle motor detected by the speed detection unit 11 and the counter-electromotive voltage constant of the spindle motor, in accordance with the determination result of the initial state determination unit 13. Here, the counter-electromotive voltage constant of the spindle motor is a value representing the ratio of counter-electromotive voltage generated by rotation number, per unit of rotational speed, and is specific to each spindle motor. This counter-electromotive voltage constant is acquired, for example, from a machining program, user input information, or an external signal.

The counter-electromotive voltage determination unit 19 compares the counter-electromotive voltage at the current speed of the spindle motor, calculated by the counter-electromotive voltage calculation unit 18, with the capacitor withstand voltage of the motor drive device (amplifier) that drives the spindle motor, thereby determining whether control stop of the spindle motor is permissible. Specifically, in a case where the counter-electromotive voltage at the current speed of the spindle motor, as calculated by the counter-electromotive voltage calculation unit 18, is smaller than the capacitor withstand voltage, the counter-electromotive voltage determination unit 19 determines that control stop of the spindle motor is permissible. As a result, it is possible to prevent failure of the amplifier due to application of a high voltage exceeding the capacitor withstand voltage, which may occur if control stop is executed while the spindle motor still has high speed and the counter-electromotive voltage, proportional to the speed, exceeds the capacitor withstand voltage.

Here, the capacitor withstand voltage of the motor drive device (amplifier) is a value specific to each amplifier.

This capacitor withstand voltage can be acquired, for example, from user input information or an external signal.

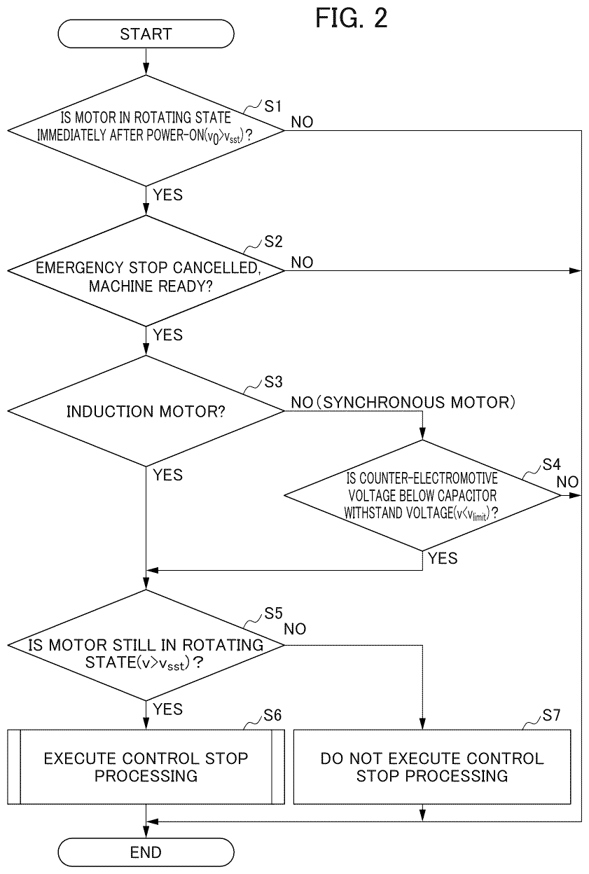

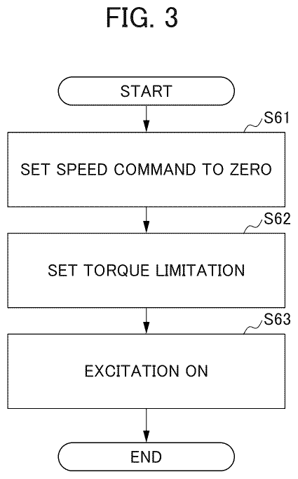

Next, control processing executed by the motor control device 1 of the present embodiment, which includes the above-described functional units, will be described in detail with reference to the flowcharts in FIG. 2 and FIG. 3. FIG. 2 is a flowchart illustrating the control processing procedure executed by the motor control device 1 of the present embodiment. FIG. 3 is a flowchart illustrating the control stop processing procedure executed by the motor control device 1 of the present embodiment. The processing illustrated in FIG. 2 and FIG. 3 is initiated and executed in response to the occurrence of a power failure.

In Step S1, it is determined whether the spindle motor is in a rotating state immediately after power-on. Specifically, it is determined whether the initial speed V₀ of the spindle motor is greater than the zero-speed detection level Vₛₛₜ. If the determination is YES, it is determined that the initial state of the spindle motor is a rotating state, and the processing proceeds to Step S2. If the determination is NO, it is determined that the initial state of the spindle motor is not a rotating state, and the control processing ends.

In Step S2, it is determined whether the emergency stop of the spindle motor has been cancelled and whether the industrial machine is ready for operation. Specifically, it is determined whether the emergency stop signal of the spindle motor (spindle motor) has switched from OFF to ON upon the user pressing the emergency stop cancellation button or the like, and whether a machine ready signal has also switched from OFF to ON in response, indicating that the machine is ready for operation. If the determination is YES, the processing proceeds to Step S3; if NO, the control processing ends.

In Step S3, it is determined whether the spindle motor is an induction motor. If the determination is YES, the processing proceeds to Step S5; if NO, the processing proceeds to Step S4.

In Step S4, since the spindle motor is a synchronous motor, it is determined whether the counter-electromotive voltage v is smaller than the capacitor withstand voltage Vₗᵢₘᵢₜ. If the determination is YES, it is safe to execute control stop, as a voltage exceeding the capacitor withstand voltage will not be applied to the amplifier, and the processing proceeds to Step S5. If the determination is NO, the processing ends, since executing control stop would result in a high voltage exceeding the capacitor withstand voltage being applied to the amplifier.

In Step S5, it is determined whether the spindle motor is still in a rotating state. Specifically, it is determined whether the current speed v of the spindle motor is greater than the zero-speed detection level Vₛₛₜ. If the determination is YES, it is determined that the spindle motor is still in a rotating state, and the processing proceeds to Step S6 to execute control stop processing. If the determination is NO, it is determined that the spindle motor is currently in a stopped state, and the processing proceeds to Step S7, ending the control processing without executing the control stop processing.

As illustrated in FIG. 3, the control stop processing in Step S6 is executed by the procedures through Steps S61 to S63.

In Step S61, the speed command is set to zero. As a result, the spindle motor transitions from an inertial rotation state to a state under the control of the motor control device 1. Then, the processing proceeds to Step S62.

In Step S62, torque limitation is set. Specifically, for example, the torque command value for the spindle motor may be initially set to a small value and gradually increased. Alternatively, the spindle motor may be decelerated from the current speed using a time constant. As a result, the shock (excessive load) applied to the spindle motor is reduced. Thereafter, the processing proceeds to Step S63.

In Step S63, excitation of the spindle motor is turned ON. As a result, the spindle motor is promptly brought to a controlled stop. Then, the control stop processing ends.

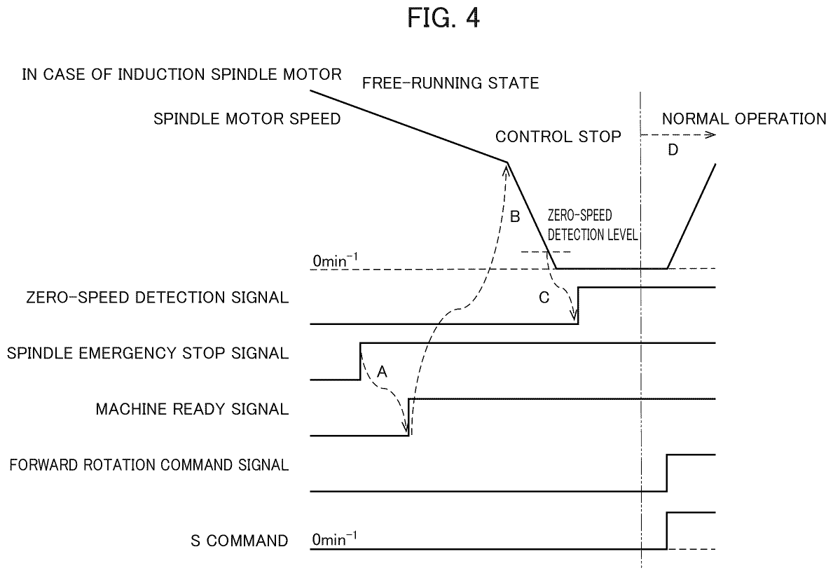

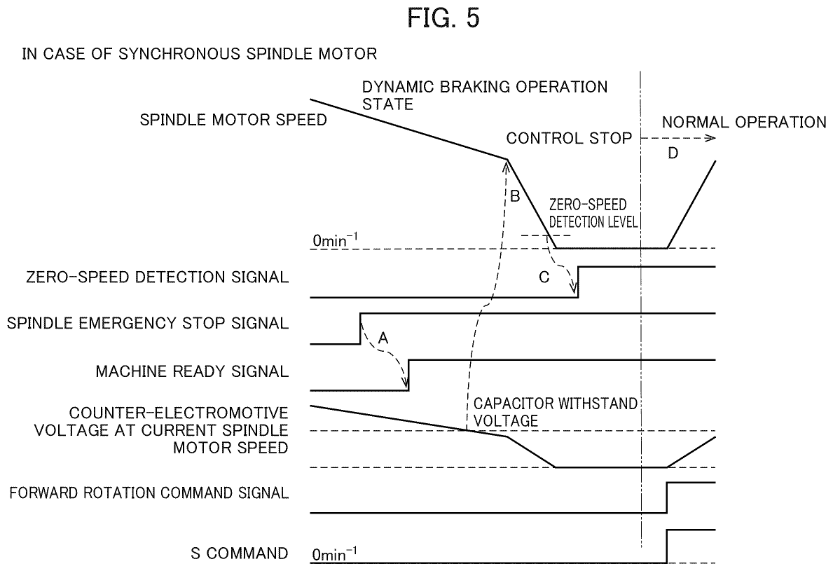

Next, the change in speed of the spindle motor that is controlled to stop by the motor control device 1 of the present embodiment after the occurrence of a power failure or the like will be described in detail with reference to the time charts of FIG. 4 and FIG. 5. FIG. 4 is a time chart illustrating an example of change in spindle speed after a power failure or the like in a case where the spindle motor is an induction motor. FIG. 5 is a time chart illustrating an example of change in spindle speed after a power failure or the like in a case where the spindle motor is a synchronous motor.

First, referring to FIG. 4, an example of change in spindle speed after a power failure or the like in a case where the spindle motor is an induction motor (induction spindle motor) will be described.

As indicated by the dashed arrow A in FIG. 4, after a power failure or the like, the spindle emergency stop signal is switched from OFF to ON by the user pressing the emergency stop cancellation button, and accordingly, the machine ready signal is also switched from OFF to ON. Then, as indicated by the dashed arrow B, the motor control device 1 initiates executing control stop, and the spindle motor transitions from a free-running state to a controlled stop state, resulting in gradual deceleration of the spindle motor speed under torque limitation. Subsequently, as indicated by the dashed arrow C, when the spindle motor speed reaches the zero-speed detection level, it is determined that the spindle motor has stopped, and the zero-speed detection signal is switched from OFF to ON. Thereafter, as indicated by the dashed arrow D, the forward rotation command signal and the S command (spindle number command) are switched from OFF to ON, and normal operation is executed.

Next, referring to FIG. 5, an example of change in spindle speed after the occurrence of a power failure or the like in a case where the spindle motor is a synchronous motor (synchronous spindle motor) will be described.

As indicated by the dashed arrow A in FIG. 5, after a power failure or the like, the spindle emergency stop signal is switched from OFF to ON by the user pressing the emergency stop cancellation button, and accordingly, the machine ready signal is switched from OFF to ON. At this time, the value of the counter-electromotive voltage at the current spindle motor speed gradually decreases and eventually reaches the capacitor withstand voltage. Then, as indicated by the dashed arrow B, the motor control device 1 initiates executing control stop, and the spindle motor transitions from the dynamic braking operation state to the controlled stop state. Accordingly, the spindle motor speed is gradually reduced under torque limitation. Subsequently, as indicated by the dashed arrow C, when the spindle motor speed reaches the zero-speed detection level, it is determined that the spindle motor has stopped, and the zero-speed detection signal is switched from OFF to ON. Thereafter, as indicated by the dashed arrow D, the forward rotation command signal and the S command (spindle number command) are switched from OFF to ON, and normal operation is executed.

As described above, the motor control device 1 according to the present embodiment provides the following advantages.

The present embodiment provides: the initial speed storage unit 12 configured to store the initial speed of the spindle motor immediately after power-on, as detected by the speed detection unit 11; the initial state determination unit 13 configured to compare the initial speed of the spindle motor with a zero-speed detection level, thereby determining whether the initial state of the spindle motor immediately after power-on is a rotating state; the stop determination unit 15 configured to compare the current speed of the spindle motor with the zero-speed detection level in accordance with the determination result of the initial state determination unit 13, thereby determining that the spindle motor should be stopped in the case of determining that the spindle motor is still in a rotating state; and the control stop unit 16 configured to execute control stop of the spindle motor, based on the determination result of the stop determination unit 15. This configuration executes control stop of the spindle motor without waiting for inertia-based rotation to cease naturally, even in a case where a power failure or the like occurs while the spindle motor is rotating, thereby allowing for shortening the startup time after power restoration.

Furthermore, the present embodiment provides: the motor type determination unit 14 configured to determine the type of the spindle motor; the counter-electromotive voltage calculation unit 18 configured to calculate the counter-electromotive voltage at the current speed of the spindle motor, based on the current speed and the counter-electromotive voltage constant of the spindle motor, in accordance with the determination result of the initial state determination unit 13; and the counter-electromotive voltage determination unit 19 configured to compare the counter-electromotive voltage at the current speed of the spindle motor with the capacitor withstand voltage of the motor drive device that drives the spindle motor, thereby determining whether control stop of the spindle motor is permissible. In the case of determining that the spindle motor is a synchronous motor, the control stop unit 16 is configured to execute control stop of the spindle motor, based on the determination results of both the stop determination unit 15 and the counter-electromotive voltage determination unit 19. This configuration makes it possible to avoid amplifier failure due to the application of a high voltage exceeding the capacitor withstand voltage, which may otherwise result from executing control stop while the spindle motor is still rotating at a high speed, and the resulting counter-electromotive voltage exceeds the capacitor withstand voltage.

Furthermore, according to the present embodiment, the control stop unit 16 is configured to execute control stop of the spindle motor by exciting the spindle motor with a speed command value of zero. In addition, the control stop unit includes the shock reduction unit 17 configured to reduce the shock to the spindle motor when executing control stop of the spindle motor, by limiting the torque command value for the spindle motor, for example by initially setting the torque command value to a small value and gradually increasing the torque command value, or by decelerating the motor from the current speed using a time constant. This configuration enables the avoidance of a situation in which, following power restoration, if a large deceleration torque is output while the spindle motor is rotating by inertia, the current feedback becomes excessive, causing shock (excessive load) to the spindle motor.

The present disclosure has been described in detail; however, the present disclosure is not limited to the individual embodiments described above. These embodiments may be subjected to various additions, replacements, modifications, partial deletions, and the like, without departing from the spirit of the present disclosure, as long as such changes fall within the scope of the claims or the spirit derived from equivalents thereof. These embodiments may also be implemented in combination. For example, in the embodiments described above, the order of operations or processing steps is merely illustrative and not limiting. The same applies to any numerical values or equations used in the descriptions of the embodiments above.

Further, with regard to the above embodiments and modifications, the following additional notes are disclosed.

### [Additional Note 1]

A motor control device (1) for controlling a spindle motor of an industrial machine, in which the motor control device includes:
a speed detection unit (11) configured to detect a speed of the spindle motor;
an initial speed storage unit (12) configured to store an initial speed of the spindle motor immediately after power-on, the initial speed being detected by the speed detection unit (11);
an initial state determination unit (13) configured to compare the initial speed of the spindle motor stored in the initial speed storage unit (12) with a preset zero-speed detection level serving as a reference for regarding the speed of the spindle motor as zero, thereby determining whether an initial state of the spindle motor immediately after power-on is a rotating state;
a stop determination unit (15) configured to compare a current speed of the spindle motor detected by the speed detection unit (11) with the zero-speed detection level, in accordance with the determination result of the initial state determination unit (13), thereby determining that the spindle motor should be stopped, in a case of determining that the spindle motor is still in a rotating state; and
a control stop unit (16) configured to execute control stop of the spindle motor in accordance with the determination result of the stop determination unit (15).

### [Additional Note 2]

In the motor control device (1) described above, the initial state determination unit (13) is configured to determine that the initial state of the spindle motor immediately after power-on is a rotating state, in a case where the initial speed of the spindle motor stored in the initial speed storage unit (12) is greater than the zero-speed detection level.

### [Additional Note 3]

In the motor control device (1) described above, the stop determination unit (15) is configured to determine that the spindle motor is still in a rotating state and determines that the spindle motor should be stopped, in a case where the current speed of the spindle motor detected by the speed detection unit (11) is greater than the zero-speed detection level.

### [Additional Note 4]

The motor control device (1) described above further includes:
a motor type determination unit (14) configured to determine a type of the spindle motor;
a counter-electromotive voltage calculation unit (18) configured to calculate a counter-electromotive voltage at a current speed of the spindle motor, based on the current speed detected by the speed detection unit (11) and a counter-electromotive voltage constant of the spindle motor, in accordance with the determination result of the initial state determination unit (13); and
a counter-electromotive voltage determination unit (19) configured to compare the counter-electromotive voltage calculated by the counter-electromotive voltage calculation unit (18) with a capacitor withstand voltage of a motor drive device that drives the spindle motor, thereby determining whether control stop of the spindle motor is permissible, in which
the control stop unit (16) is configured to execute control stop of the spindle motor in accordance with the determination results of the stop determination unit (15) and the counter-electromotive voltage determination unit (19), in a case where the motor type determination unit (14) determines that the spindle motor is a synchronous motor.

### [Additional Note 5]

In the motor control device (1) described above, the counter-electromotive voltage determination unit (19) is configured to determine that control stop of the spindle motor is permissible in a case where the counter-electromotive voltage at the current speed of the spindle motor, calculated by the counter-electromotive voltage calculation unit (18), is smaller than the capacitor withstand voltage.

### [Additional Note 6]

In the motor control device (1) described above, the control stop unit (16) is configured to execute control stop of the spindle motor by exciting the spindle motor with a speed command value of zero.

### [Additional Note 7]

In the motor control device (1) described above, the control stop unit (16) includes a shock reduction unit (17) configured to reduce shock to the spindle motor when executing control stop of the spindle motor.

### [Additional Note 8]

In the motor control device (1) described above, the shock reduction unit (17) is configured to limit a torque command value for the spindle motor.

### [Additional Note 9]

In the motor control device (1) described above, the shock reduction unit (17) gradually increases the torque command value for the spindle motor.

### [Additional Note 10]

In the motor control device (1) described above, the shock reduction unit (17) is configured to decelerate the spindle motor from the current speed, detected by the speed detection unit (11), using a time constant.

### EXPLANATION OF REFERENCE NUMERALS

1: motor control device
11: speed detection unit
12: initial speed storage unit
13: initial state determination unit
14: motor type determination unit
15: stop determination unit
16: control stop unit
17: shock reduction unit
18: counter-electromotive voltage calculation unit
19: counter-electromotive voltage determination unit

1. A motor control device configured to control a spindle motor of an industrial machine, the motor control device comprising:
a speed detection unit configured to detect a speed of the spindle motor;
an initial speed storage unit configured to store an initial speed of the spindle motor immediately after power-on, the initial speed being detected by the speed detection unit;
an initial state determination unit configured to compare the initial speed of the spindle motor stored in the initial speed storage unit with a preset zero-speed detection level serving as a reference for regarding the speed of the spindle motor as zero, thereby determining whether an initial state of the spindle motor immediately after power-on is a rotating state;
a stop determination unit configured to compare a current speed of the spindle motor detected by the speed detection unit with the zero-speed detection level, in accordance with a determination result of the initial state determination unit, thereby determining that the spindle motor should be stopped, in a case of determining that the spindle motor is still in a rotating state; and
a control stop unit configured to execute control stop of the spindle motor, in accordance with a determination result of the stop determination unit.

2. The motor control device according to claim 1, wherein the initial state determination unit determines that the initial state of the spindle motor immediately after power-on is a rotating state, in a case where the initial speed of the spindle motor stored in the initial speed storage unit is greater than the zero-speed detection level.

3. The motor control device according to claim 1, wherein the stop determination unit determines that the spindle motor is still in a rotating state and determines that the spindle motor should be stopped, in a case where the current speed of the spindle motor detected by the speed detection unit is greater than the zero-speed detection level.

4. The motor control device according to claim 1, further comprising:
a motor type determination unit configured to determine a type of the spindle motor;
a counter-electromotive voltage calculation unit configured to calculate a counter-electromotive voltage at the current speed of the spindle motor, based on the current speed detected by the speed detection unit and a counter-electromotive voltage constant of the spindle motor, in accordance with the determination result of the initial state determination unit; and
a counter-electromotive voltage determination unit configured to compare the counter-electromotive voltage at the current speed of the spindle motor, as calculated by the counter-electromotive voltage calculation unit, with a capacitor withstand voltage of a motor drive device that drives the spindle motor, thereby determining whether control stop of the spindle motor is permissible,
wherein the control stop unit is configured to execute control stop of the spindle motor in accordance with the determination results of the stop determination unit and the counter-electromotive voltage determination unit, in a case where the motor type determination unit determines that the spindle motor is a synchronous motor.

5. The motor control device according to claim 4, wherein the counter-electromotive voltage determination unit is configured to determine that control stop of the spindle motor is permissible in a case where the counter-electromotive voltage at the current speed of the spindle motor calculated by the counter-electromotive voltage calculation unit is smaller than the capacitor withstand voltage.

6. The motor control device according to claim 1, wherein the control stop unit is configured to execute control stop of the spindle motor by exciting the spindle motor with a speed command value of zero.

7. The motor control device according to claim 1, wherein the control stop unit includes a shock reduction unit configured to reduce shock to the spindle motor when executing control stop of the spindle motor.

8. The motor control device according to claim 7, wherein the shock reduction unit is configured to limit a torque command value for the spindle motor.

9. The motor control device according to claim 7, wherein the shock reduction unit is configured to gradually increase a torque command value for the spindle motor.

10. The motor control device according to claim 7, wherein the shock reduction unit is configured to decelerate the spindle motor from the current speed detected by the speed detection unit using a time constant.
